(19) United States
(12) Patent Application Publication
(10) Pub. No.: US 2019/0043509 A1
(43) Pub. Date: Feb. 7, 2019

(54) AUDIO PRIVACY BASED ON USER IDENTIFICATION

(71) Applicant: Cirrus Logic International Semiconductor Ltd., Edinburgh (GB)

(72) Inventor: Seth Suppappola, Tempe, AZ (US)

(73) Assignee: Cirrus Logic International Semiconductor Ltd., Edinburgh (GB)

(21) Appl. No.: 15/669,607

(22) Filed: Aug. 4, 2017

(51) Int. Cl. G10L 17/22; G10L 17/04; G10L 15/08; G10L 17/06

(52) U.S. Cl. CPC G10L 17/22; G10L 17/04; G10L 2015/088; G10L 17/06; G10L 15/08

(57) ABSTRACT

A method and apparatus for audio privacy may be based on user identification. An audio signal containing speech may be analyzed, identifying a user to which the speech belongs and determining a user class for the user. The speech may be uploaded to a remote device based on whether the user class for the user is a public user class or a private user class. This allows certain users to opt-out of having their speech uploaded through public networks. The user identification may be based on voice biometrics.

### FIELD OF THE DISCLOSURE

The instant disclosure relates to speech processing systems. More specifically, portions of this disclosure relate to privacy controls for speech processing systems.

### BACKGROUND

As smart devices become ubiquitous, increasing amounts of data are collected by such devices. In particular, smart devices are increasingly incorporating speech capture technology, such as far-field voice recognition technology, to recognize and process speech from users. Such devices may often be configured to recognize and process speech from multiple users, even distinguishing between users from whom the commands are received. Smart devices may also be always-on so that speech from users is always collected and processed.

For example, a smart home device 104 may be situated in a room 100 to receive input through microphones as illustrated in FIG. 1. A first user 102A and a second user 102B may also be in the room 100, along with multiple noise sources such as TV 110A and radio 110B. The smart home device 104 may utilize speech capture technology for receiving audio signals including speech, such as voice commands, from users 102A-B. Some audio processing on inputs received through the microphones may be performed on another device. For example, audio samples may be uploaded to the cloud for speech recognition. However, the transmission of audio samples to another device risks allowing unintended parties' access to the audio samples. This scenario can result in a loss of confidentiality of speech in the room with the device 104. Some users may find such intrusions on private conversation inhibiting to the use or adoption of smart home device 104.

Shortcomings mentioned here are only representative and are included simply to highlight that a need exists for improved audio processing techniques, particularly for privacy-settings determination employed in conjunction with audio signal transmission and processing. Embodiments described herein address certain shortcomings but not necessarily each and every one described here or known in the art. Furthermore, embodiments described herein may present other benefits than, and be used in other applications than, those of the shortcomings described above.

### SUMMARY

To alleviate privacy concerns of users, users may be allowed to govern whether their speech is uploaded to the cloud through the application of user privacy policies. An audio signal containing speech may be filtered based on the user whose voice is identified in the audio signal. When a user's voice is identified as associated with a private user, audio data containing that user's voice is not transmitted over a public network to a remote device. Instead, the audio may be processed locally on the device, locally on the same network, or deleted without further processing.

A method may begin with receiving an audio input signal containing speech. The received audio signal may include multiple microphone signals from different locations. For example, a smart device may be recording audio signals in a room. A user may be identified based, at least in part, on characteristics of the speech. For example, user identification may be based on a comparison of physiological and/or behavioral characteristics of received speech with a database of users and corresponding speech samples or speech characteristic archives. User identification may be performed by a user identification system such as described in U.S. Pat. No. 9,042,867 to Gomar and entitled “SYSTEM AND METHOD FOR SPEAKER RECOGNITION ON MOBILE DEVICES,” which is hereby incorporated by reference. A user class may be determined for the user. For example, a determination may be made of whether the user belongs to a public or private user class. A public user class may allow for uploading of speech to a remote system, while a private user class may prevent such uploading. A user may enroll in a specific user class based on a received speech pattern, including information for identifying the user and indicating a user class for the user. The speech may be uploaded to a remote system when the determined user class is a class that allows uploading of speech, for example a public class. The speech may not be uploaded when the determined user class is a class that does not allow uploading of speech to the remote system, for example a private class. In some embodiments, identification of a user or a user class may be used to decide other factors regarding how speech is processed. For example, the remote system to which the speech is uploaded may be selected based on the determined user class.

An apparatus, such as a smart device, may include an audio controller or another integrated circuit for performing portions or all of the method described herein. The apparatus may also include one or more microphones to collect an audio input signal containing speech. Although smart home devices are described in example embodiments of the present disclosure, they are not limited in application to smart home devices. Biometric identification of a user and subsequent restriction on the upload of audio data from the identified user may be applied to other systems, such as cellular phones, tablet computers, personal computers, and/or entertainment devices.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration of a room with a smart device.

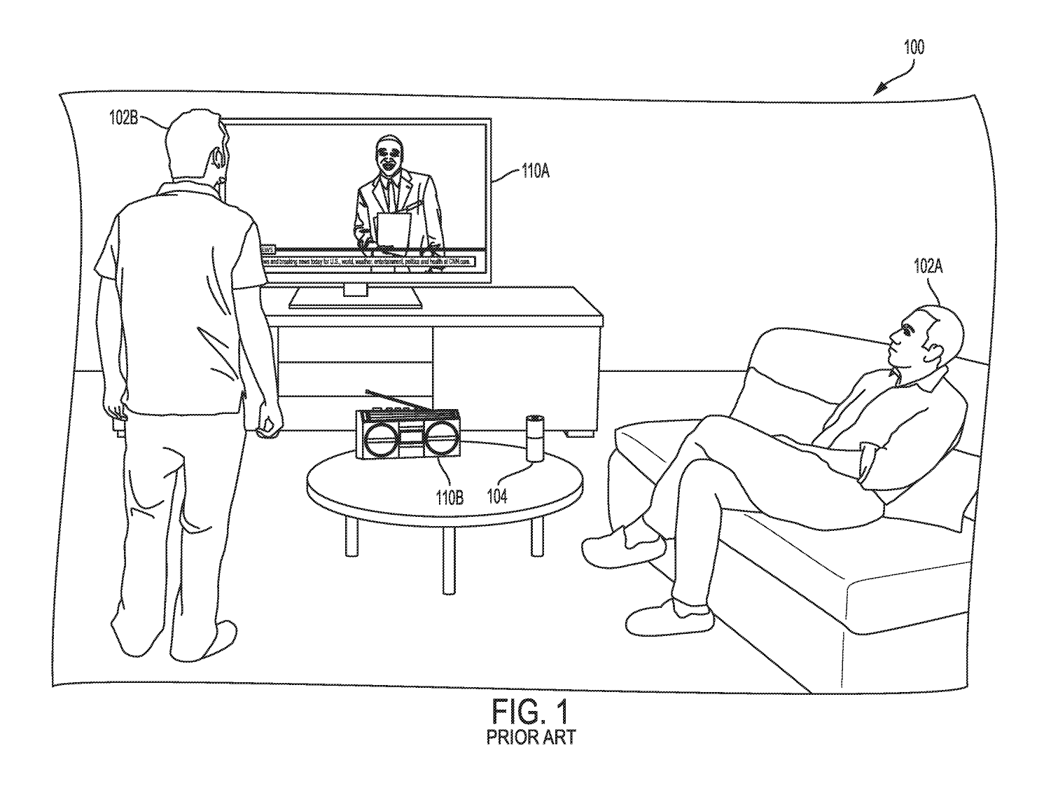

FIG. 2 is an illustration of a smart device according to some embodiments of the disclosure.

FIG. 3 is an illustration of a smart device for receiving an audio signal including speech and uploading the speech to the cloud according to some embodiments of the disclosure.

FIG. 4 is an illustration of a voice recognition system according to some embodiments of the disclosure.

FIG. 5 is an illustration of a system for selectively uploading speech to the cloud based on a biometrically determined user profile according to some embodiments of the disclosure.

FIG. 6 is an illustration of a method for determining whether to upload speech to the cloud based on a biometrically determined user profile according to some embodiments of the disclosure.

FIG. 7 is an illustration of a method for creation a biometric voice print for a user associated with a user class according to some embodiments of the disclosure.

### DETAILED DESCRIPTION

A smart device may contain biometric mute functionality to govern analysis and dissemination of an audio signal including speech based on a user class for a user originating the speech. The smart device may analyze an audio signal containing speech, isolating speech of one or more users from background noise and the speech of other users, and determine a user class for the user based on the speech. The smart device may then upload the speech to a remote device based on whether the user class for the user is public or private.

As smart devices, such as smart phones, smart speakers, security cameras, smart TVs, computers, tablets, smart cars, smart home devices, and other smart devices, proliferate, becoming increasingly common in public, in our homes, and in our workplaces, they collect increasing amounts of information about the environment around them, including audio, visual, and other types of environmental information. Privacy becomes an increasing concern due to the sensitive nature of some data collected by smart devices. Some smart devices contain always-listening technology, constantly receiving audio input from their environment to monitor for user commands. Many smart devices also upload received information, such as speech, to the cloud, for example to servers of a data center, for analysis and storage. Privacy concerns of users, with respect to received speech, may be addressed by uploading speech of users who find uploading of collected speech to be acceptable and preventing uploading of speech of users who find uploading of collected speech to be unacceptable.

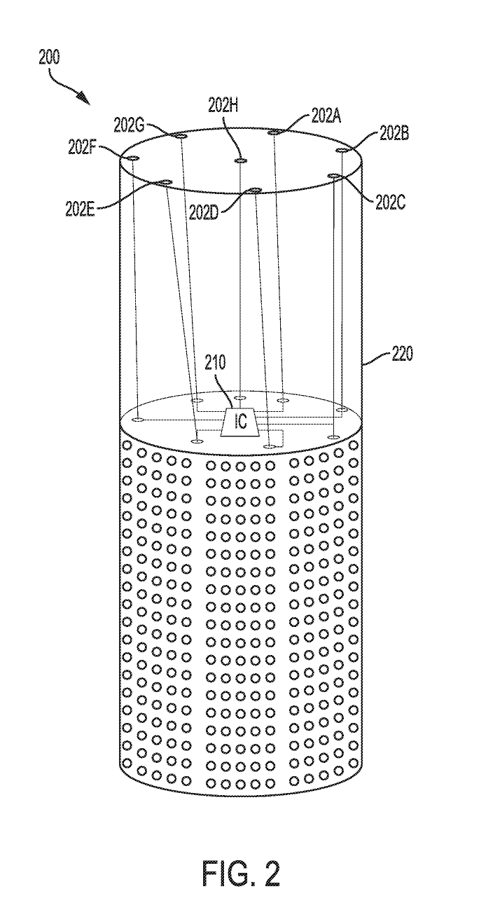

An example smart device 200 containing speech capture technology, such as far-field voice recognition technology, is illustrated in FIG. 2. The smart home device 200 may have several microphones 202A-H configured to receive an audio signal containing speech from one or more users. An integrated circuit 210 may process the audio signal received by the microphones 202A-H. For example, the integrated circuit 210 may filter ambient audio from the signal from sources other than users such as TVs, radios, and other sound producing objects and events and to isolate speech received from users. The integrated circuit 210 may also distinguish between and identify one or more users and may determine a location of the users based on audio received from the users. For example, the integrated circuit 210 may analyze speech received from a user via microphones 202A-H, comparing the timing and volume of the audio received at each of microphones 202A-H, to determine a location of the user.

Identification of a user based on received speech from the user may be performed based on physiological and/or behavioral characteristics of the user. Such characteristics may derive from the spectral envelope, the vocal tract of the user, supra-segmental features, and/or voice source characteristics of a user. In identifying a user based on received speech, a portion of the received speech from the user may be analyzed and compared with recorded speech samples or models associated with a library of users. If a match between a portion of the received speech and a speech sample or model of a user from the library of users meets or exceeds a threshold, a determination may be made that the received speech belongs to the user associated with the speech sample or model.

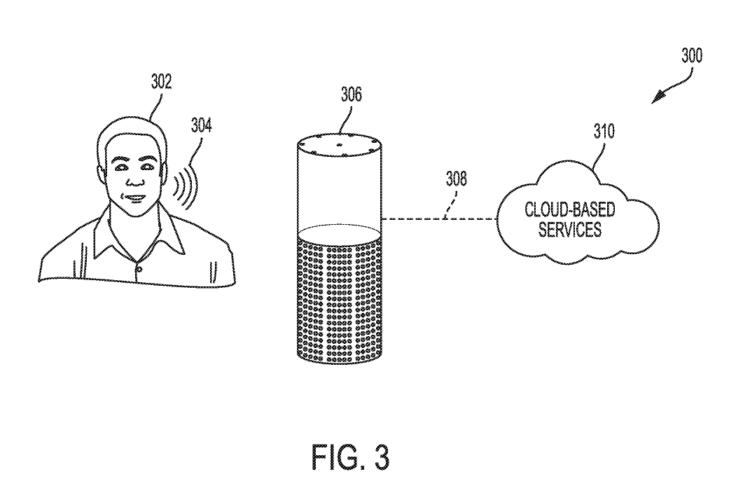

A smart device may upload speech received from a user for analysis and/or use by cloud-based services. A system 300 incorporating a smart device 306 is illustrated in FIG. 3. A user 302 may speak, generating an audio signal 304 containing speech. The smart device 306 may perform local processing on the received audio signal containing speech, such as isolating the speech from other ambient noise of the audio signal 304. The smart device 306 may then transmit 308 the audio signal 304, or a representation of at least a portion of the audio signal 304, to a remote device, such as a server in a data center, for use by cloud based services 310.

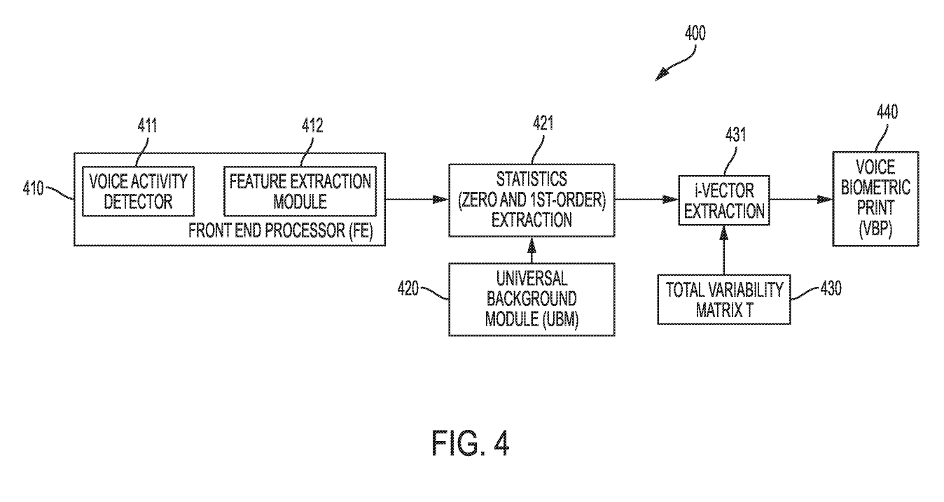

The smart device 306 may be configured to identify a user speaking in a received audio signal. For example, FIG. 4 provides a high-level diagram of a speaker recognition system 400 that may be incorporated in a smart device to receive an audio signal containing speech and determine a user class for the user who issued the speech. The system 400 may enroll users by collecting a voice biometric print (VBP) from a user and may determine if received speech is an enrolled user by comparing the received speech with the collected voice biometric print. According to the embodiment, speaker recognition processes start in a front-end processor 410, which may include a voice activity detector 411 and a feature extraction module 412.

Voice activity detector (VAD) 411 may be circuitry integrated with a microphone or other audio input device coupled to a processor or may be executed as a specialized software application that is coupled to a standard audio input device through an associated device driver. Voice activity detector 411 may be implemented so that it remains essentially idle except for a single process that detects audio input that can be automatically classified as being associated with a human or human-like voice. Voice activity detector 411 may ignore all audio received from audio input devices until it detects the presence of a human voice, and then begins to collect digital audio and to pass it on to feature extraction module 412. Voice activity detector 411 may be activated upon explicit request from a user or a third-party application. During enrollment, the speaker may be requested to speak certain test phrases, and voice activity detector 411 may capture spoken phrases as digital audio and pass the digital audio data to feature extraction module 412.

Feature extraction module 412 receives an input stream of audio data to identify speech and/or a user that is speaking. Many feature extraction techniques may be used. In some embodiments, feature extraction module 412 breaks incoming audio streams into short (e.g., 20 milliseconds in duration) packets and then analyzes each packet to produce a frame or feature vector. Front-end processor 410 may receive samples representing audio and extract frames from the sampled audio and pass the extracted features for each utterance to one or more statistics extraction modules 421. Audio data received by front end processor 410 can be in, for example, PCM (Pulse Code Modulation), AAC (Advanced Audio Coding), HE-AAC (High Efficiency-AAC), G.722, various sub-standards of MPEG-4, or WMA (Windows Media Audio).

Extracted features for each utterance are passed to statistics extraction module 421, which is a software, firmware, or hardware module adapted to receive utterance feature sets and to compute a variety of statistics regarding them. In some embodiments, zero-order and first-order statistics are computed using both the extracted features of an utterance and a universal background model 420 (UBM), which represents general, person-independent and phrase-independent feature characteristics, although it could be phrase-dependent if it is desirable to have a more ad hoc UBM.

Statistics computed by statistics extraction module 421 are passed to iVector extraction module 431. The extraction module 431 may also receive as input a total variability matrix T 430, which is a matrix whose columns span a subspace where the most significant speaker and session variability is confined, and thus is used to characterize the degree to which a given speaker's voice is likely to vary from like utterance to like utterance within a session and over longer periods of time (if data is available for longer periods of time). The output of iVector extraction module 431 is a voice biometric print 440 (also commonly called a “voiceprint”), which represents a mathematical model of a speaker's vocal tract and a particular channel (i.e., mobile phone, land line phone, microphone in noisy area, etc.), and is analogous to a user's fingerprint.

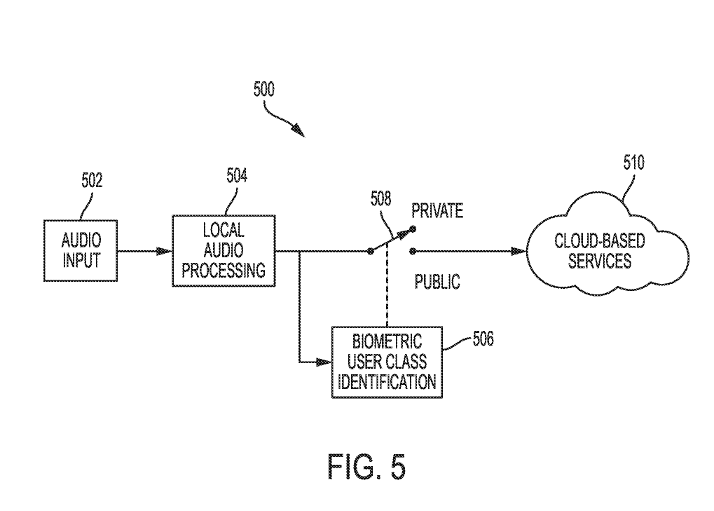

The speaker recognition system 400 may be used to determine a user class of a speaker, and the determined user class used to determine how an audio signal is further processed. For example, speech may be selectively uploaded for use by cloud-based services based on a user class of a user by whom the speech was issued. The following operations based on user class may rely on the output of speaker recognition system 400, but other speaker recognition systems may also be used with the described operations. FIG. 5 is an illustration of an example system 500 for selectively uploading speech based on a determined user class of a user. An audio signal containing speech may be received via an audio input module 502. The audio input module 502 may include one or more microphones or may receive the audio signal from one or more microphones. The audio input module 502 may include a voice activity detector, as described above. The audio signal may be processed at a local audio processing module 504. The local audio processing module 504 may, for example, isolate speech of a user from ambient noise also contained in the audio signal. The local audio processing module 504 may isolate speech from multiple users. An audio signal containing speech may be transmitted to a biometric user class identification module 506. The biometric user class identification module 506 may analyze the received audio signal to identify a user based, at least in part, on characteristics of the speech, such as physiological and/or behavioral characteristics of the speech. For example, the biometric user class identification module 506 may compare characteristics of the speech against characteristics of a speech sample, such as a VBP associated with a user in a user profile and stored in a memory of a smart device, to determine if the characteristics of the received speech match characteristics of speech associated with a user. Alternatively, a speech sample, such as a VBP, associated with a user may be stored in a cloud and accessed by the smart device to compare the sample with received speech.

Users may be classified based on their speech data privacy preferences. After the user is identified, the biometric user class identification module 506 may determine a user class for the user, such as private or public. The biometric user class identification module 506 may control path 508 based on the determined user class. Alternatively, the biometric user class identification module 506 may transmit a user class to another component, such as a controller, controlling the path 508. If the user is determined to be of a private user class, the path 508 may be operated to prevent an audio signal containing speech from being transmitted to one or more cloud-based services 510. The path 508 may also be operated to prevent an audio signal from being transmitted to cloud-based services 510 if it is unable to identify a user and/or a user class for a user. If the user is determined to be of a public user class, the path 508 may be operated to transmit the audio signal to one or more cloud based services 510.

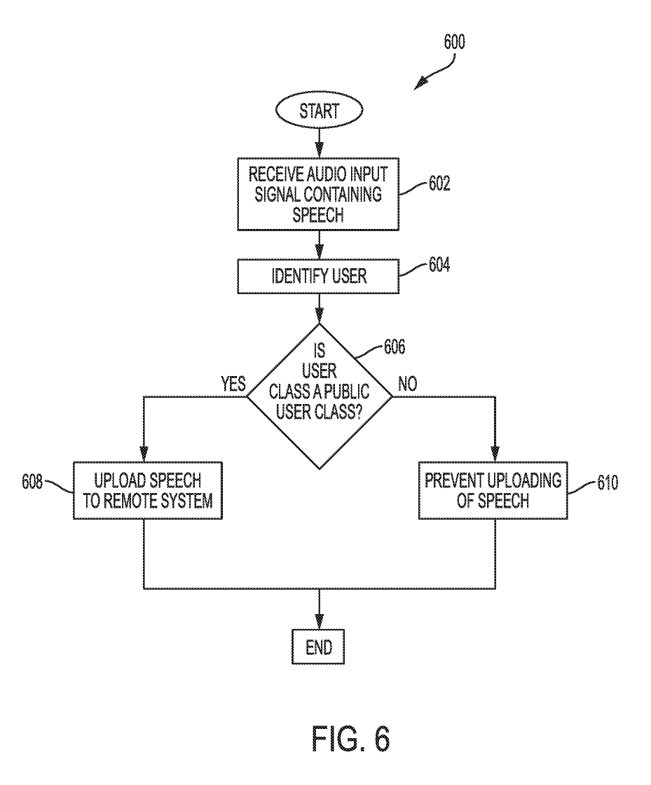

Smart devices may receive user speech and decide whether to upload the speech to one or more remote systems based on a user class of the user. A method 600 for uploading or preventing uploading of speech to a remote system based on a user class of a user from whom the speech was issued is illustrated in FIG. 6. The method 600 may begin, at step 602, with receipt of an input audio signal containing speech. The received audio signal may include speech from multiple users and may also include ambient noise. The received audio signal may optionally be processed to isolate speech of a user. For example, the received audio signal may be filtered to remove ambient noise. As another example, speech from a user may be isolated from speech from other users based on a position of the first user and a position of the second user relative to the microphones. For example, timing differences in the receipt of speech by multiple microphones at different locations may be analyzed to determine a location of the first user and the second user and to separate the speech of the first user from the speech of the second user.

After the audio signal containing speech has been received, a user from whom the speech was issued may be determined, at step 604, based on characteristics of the received speech. For example, the speech may be compared with multiple VBPs associated with multiple users to determine if the speech matches one of the VBPs. Voice samples, such as VBPs, may be associated with a user, such as in a user profile, and may be stored on a smart device or in a remote system. Physiological and/or behavioral characteristics of the received speech may be compared against physiological and/or behavioral characteristics of a previously recorded speech sample, or speech characteristics stored in a VBP for a user. If a user is not identified, the speech may be prevented from being transmitted to a remote system.

A user may be classified as a member of one or more user classes. Arbitrary classes may be defined for groups of users or individual users. In one embodiment, two user classes may be defined based on whether the user is a public user that accepts transmission of their speech over public networks or whether the user is a private user that does not accept transmission of their speech over public networks. An example is presented below using two user classes defined as public users and private users. However, any number of user classes may be defined for users.

When a user is identified, a determination may be made, at step 606, as to whether the user is a member of a public user class. A user class may be associated with a user. For example, an identification of a user class for the user may be stored in a user profile for the user. One user may be a member of a public user class, allowing speech to be uploaded to remote systems, while another user may be a member of a private user class, blocking speech from being uploaded to a remote system. In some embodiments, additional classes may exist allowing further discrimination on the upload process. For example, a user may be a member of a customized user class that allows uploading of speech only to certain remote systems. As another example, a user may be a member of a customized user class that allows uploading of speech during specific times of the day. In these examples, even with further criterion a decision as to public or private may be determined for controlling the transmission of data. That is, a customized user class operating during the period of time allowing upload may be classified as a public user class. For such custom classes, the decision at step 606 may be a determination as to whether the particular speech received from the user identified at step 604 is authorized for transfer over a public network to a recipient of the speech. The determination at step 606 to proceed to step 608 or step 610 may be based on one or more factors, including user, user class, destination address of information in speech, content of speech, application associated with the content of speech, and/or the application currently running on the device.

If the user is determined to be a member of a public user class, the speech may be uploaded to one or more remote systems at step 608. If the user is not a member of a public user class, for example if the user is a member of a private user class, speech may be prevented from being uploaded to remote systems at step 610. Other actions may be performed at step 608 based on a determination regarding permissions at step 606 in addition to or instead of uploading the speech. For example, the audio input signal may be partially processed locally by the device to determine the content. In one embodiment, the local device may recognize that the user's speech included an instruction regarding a playback of a video file on a multimedia device. The local device may adjust settings of the multimedia device to prepare for playback of the video file, and simultaneously transmit speech to a remote device which will determine the requested video and stream the requested video to the multimedia device.

Some users may want only certain kinds of speech uploaded. Users may control the transfer of speech based on a privacy setting and a public setting in the user class or user profile. A user or administrator may set a public setting for certain criteria (such as certain speech, time of day, or the like) and a privacy setting for other criteria. Speech may be uploaded or prevented from being uploaded to one or more remote systems based on a type of speech received in the audio signal containing speech. For example, a portion of received speech may be analyzed to obtain an indication of content of the speech. The speech may be uploaded if the content is a type of content for which uploading of speech is allowed. Users may restrict uploading of speech to certain speech types, for example, by including such restrictions in a user profile. Such restrictions may be specified by a user class of the user. Content restrictions can include restrictions based on words contained in speech. For example, a user may restrict uploading of speech to only speech following a default or user-selected trigger word or phrase. Alternatively, speech may be analyzed to determine if it contains personal or financial information and uploading of speech containing such information may be prevented.

Users may enroll as members of public or private classes through many interfaces and methods, some embodiments of which are described herein. In a two-user class example when a user enrolls, the user may classify herself as a user that allows transmission of speech over public networks or a user that disallows transmission of speech over public networks. However, a user may also be allowed to customize what speech is transmitted over public networks to a remote system. For example, the user may choose to allow access by certain applications to transmit speech over public networks. As another example, the user may choose to allow access by time of day and set custom schedules for when one or more applications may transmit speech over public networks. Some preset user profiles may also be established to allow a user to customize transmission of speech. For example, a multimedia user profile may be predetermined that configures a user to allow transmission of speech commands regarding playback of video content after 5 pm to be transmitted over a public network. All other speech in this example would be blocked from upload to a public network.

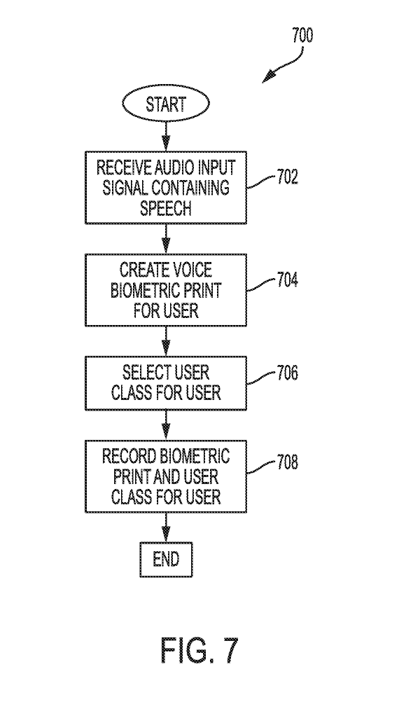

An example method 700 for enrolling a user as a member of a public class is illustrated in FIG. 7. The method 700 may begin with receiving an audio input signal containing speech at step 702. The audio signal may, for example, include speech containing a trigger word or phrase indicating that the user who issued the speech would like to create a user profile and/or associate their user profile with a specific user class. The speech contained in the received audio may be isolated and used, at step 704, to create a VBP for the user. The VBP for the user may be associated with the user profile. Alternatively, other profiles or speech samples may be received and saved, associated with the user profile, to be used to determine if speech received in the future is from the user. The received audio signal may also include speech specifying a desired user class for the user, and a user class for the user may be selected, at step 706, based on the received audio. User class may also or alternatively be selected according to other input methods, such as through a display screen or web interface. The user class and VBP or other speech samples may be stored, at step 708 in a user profile on a smart device or on a remote storage device. Alternatively or additionally, user classes for preexisting users, such as users for which user profiles have already been created, may be altered in response to receipt of speech specifying a new user class for the user. After a user is enrolled, the user may be allowed to modify their profile, such as by granting access to additional applications, through speech commands or through other input methods, such as a web interface or mobile application interface.

The schematic flow chart diagrams of FIGS. 6 and 7 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The operations described above as performed by a controller may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wire connections or through programming by instructions contained in firmware. Further, the logic circuitry may be configured as a general purpose processor capable of executing instructions contained in software. In some embodiments, the integrated circuit (IC) that is the controller may include other functionality. For example, the controller IC may include an audio coder/decoder (CODEC) along with circuitry for performing the functions described herein. Such an IC is one example of an audio controller. Other audio functionality may be additionally or alternatively integrated with the IC circuitry described herein to form an audio controller.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method, comprising:
receiving an audio input signal comprising speech;
identifying a user based, at least in part, on characteristics of the speech;
determining a user class for the user, wherein the user class comprises a privacy setting; and
performing an action based, at least in part, on the determined user class,
wherein the step of performing an action is based, at least in part, on criteria defined for the determined user class regarding whether the speech is allowed by the user for transmission over a public network or disallowed by the user for transmission over the public network.

2. The method of claim 1, wherein the step of performing an action comprises uploading the speech to a remote system when allowed by the determined user class for the user.

3. The method of claim 1, wherein determining the user class for the user comprises classifying the user as one of a public user class and a private user class, wherein the public user class allows uploading of speech to the remote system.

4. (canceled)

5. The method of claim 1, wherein the step of performing an action is based, at least in part, on a destination of the speech on the public network.

6. The method of claim 1, wherein the step of uploading the speech comprises analyzing a portion of the speech to obtain an indication of a content of the speech; and uploading the speech when uploading of the indicated content is allowed by the determined user class for the user.

7. The method of claim 6, wherein the step of analyzing the speech comprises identifying a trigger word within the speech; and uploading a portion of the speech from the audio input signal when the trigger word is identified in the speech.

8. The method of claim 1, further comprising preventing uploading of the speech to the remote system when not allowed by the determined user class for the user.

9. The method of claim 1, wherein the step of receiving an audio input signal comprises receiving a plurality of microphone signals from different locations.

10. The method of claim 1, further comprising enrolling the user by receiving criteria regarding whether the speech is allowed by the user for transmission over a public network or disallowed by the user for transmission over a public network.

11. The method of claim 10, wherein the step of enrolling the user comprises receiving a speech pattern indicating the user class for the user, wherein the speech pattern comprises information for identifying the user.

12. The method of claim 10, wherein the step of enrolling the user comprises receiving a list of applications permitted to receive the speech over a public network.

13. The method of claim 1, wherein the user class further comprises a public setting.

14. The method of claim 13, wherein the step of performing an action comprises preventing the speech from being accessed by a remote system based, at least in part, on the public setting.

15. The method of claim 13, wherein the step of performing an action comprises performing an action in allowing and in preventing access to the speech by a remote system in a manner that is based on and consistent with a mixed setting that accounts for both a privacy setting and the public setting.

16. An apparatus, comprising:
an audio controller configured to perform steps comprising:
receiving an audio input signal comprising speech;
identifying a user based, at least in part, on characteristics of the speech;
determining a user class for the user, wherein the user class comprises a privacy setting; and
performing an action based, at least in part, on the determined user class,
wherein the step of performing an action is based, at least in part, on criteria defined for the user class regarding whether the speech is allowed by the user for transmission over a public network or disallowed by the user for transmission over a public network.

17. The apparatus of claim 16, wherein performing an action comprises uploading the speech to a remote system when allowed by the determined user class for the user.

18. The apparatus of claim 16, wherein determining the user class for the user comprises classifying the user as one of a public user class and a private user class, wherein the public user class allows uploading of speech to the remote system.

19. (canceled)

20. The apparatus of claim 16, wherein the step of performing an action is based, at least in part, on a destination of the speech on the public network.

21. The apparatus of claim 16, wherein the step of uploading the speech comprises analyzing a portion of the speech to obtain an indication of a content of the speech; and uploading the speech when uploading of the indicated content is allowed by the determined user class for the user.

22. The apparatus of claim 21, wherein the step of analyzing the speech comprises identifying a trigger word within the speech; and uploading a portion of the speech from the audio input signal when the trigger word is identified in the speech.

23. The apparatus of claim 16, wherein the audio controller is further configured to perform steps comprising preventing uploading of the speech to the remote system when not allowed by the determined user class for the user.

24. The apparatus of claim 16, wherein the step of receiving an audio input signal comprises receiving a plurality of microphone signals from different locations.

25. The apparatus of claim 16, wherein the audio controller is further configured to perform steps comprising enrolling the user by receiving criteria regarding whether the speech is allowed by the user for transmission over a public network or disallowed by the user for transmission over a public network.

26. The apparatus of claim 25, wherein the step of enrolling the user comprises receiving a speech pattern indicating the user class for the user, wherein the speech pattern comprises information for identifying the user.

27. The apparatus of claim 25, wherein the step of enrolling the user comprises receiving a list of applications permitted to receive the speech over a public network.

28. The apparatus of claim 16, wherein the user class further comprises a public setting.

29. The apparatus of claim 28, wherein the step of performing an action comprises preventing the speech from being accessed by a remote system based, at least in part, on the public setting.

30. The apparatus of claim 28, wherein the step of performing an action comprises performing an action in allowing and in preventing access to the speech by a remote system in a manner that is based on and consistent with a mixed setting that accounts for both the privacy setting and the public setting.
